(19) United States
(12) Patent Application Publication
(10) Pub. No.: US 2002/0033834 A1
(43) Pub. Date: Mar. 21, 2002

(54) Method of and apparatus for secondary application of film image

(76) Inventors: Fumiko Beniyama, Kawasaki (JP); Toshio Moriya, Kawasaki (JP); Haruo Takeda, Kawasaki (JP)

Correspondence Address: MATTINGLY, STANGER & MALUR, P.C., ATTORNEYS AT LAW, 104 EAST HUME AVENUE, ALEXANDRIA, VA, 22301, US

(21) Appl. No.: 09/796,556

(22) Filed: Mar. 2, 2001

(30) Foreign Application Priority Data
Sep. 18, 2000 (JP) 2000-286847

(51) Int. Cl. G09G 5/00

(52) U.S. Cl. 345/635

(57) ABSTRACT

In a stereoscopic image producing apparatus comprising an image displaying device, a memory device for storing celluloid image data with no display of an object to be composed, visual point position data indicating positional relationship between the object and a position of a visual point and background three-dimensional CG data to be composed, a CPU operates according to a program stored in a main memory device 100 to produce a stereoscopic image from two sets of composed image data as viewed from different visual points, each set of said data being produced by conducting the steps of calculating a visual point position of the object included in the celluloid image, determining position and size of a cylindrical model based on the result of the calculation, mapping the celluloid image to the cylindrical model and composing the mapped data with the three-dimensional CG data.

### BACKGROUND OF THE INVENTION

The present invention is relating to reuse of an image recorded on a film and more particularly, to adding value to a celluloid image, which is an image obtained by separating or extracting an object, by producing a stereoscopic image from the celluloid image. The celluloid image includes a secondary image, which includes an animation. Further, the present invention is relating to conversion of a secondary celluloid (cel) animation to a stereoscopic one in which a stereoscopic image is produced by applying three-dimensional composition to existing secondary celluloid animation by using computer system.

The celluloid animation has been produced by laminating on a background image a plurality of transparent sheets called celluloid on which objects are drawn and taking pictures of photographs frame by frame continuously on a 35 mm film. Most of classical celluloid animations called as masterpieces produced in 1950's and 1960's are maintained in a form of film.

However, the deterioration of quality by physical and chemical damages with the years is unavoidable and hence attention is directed to semipermanent storage of them by digitization.

In the recent production of animations, most of the works are digitized. Thus, the digitization of celluloid animations is gradually generalized such as digitization of classical animations or digitized production of recent animations. The digitized data are readily corrected and stored and adapted to be stored semipermanently.

However, most of the digitized celluloid animations are used only for display and although the management, correction or storage without deterioration of the data becomes easy, it is very seldom that the celluloid image data are used for adding value such as application to another representation procedure.

Incidentally, with respect to digitized celluloid animations, there exists the following conventional literature.

In Japanese Patent Publication Kokai Hei 10-40411 “Method of and Apparatus for Producing Dynamic Images”, the layers of image data are parallelly processed layer by layer thereby making the process time shorter and the parameter in composition is devised.

### SUMMARY OF THE INVENTION

However, in the conventional technique, application of the digitized celluloid animation, such as conversion to three-dimensional one or to stereoscopic one is not considered. In this manner, in the conventional celluloid animation, representation procedure is poor so that only a two-dimensional representation is used.

The present invention has been done by considering the above problem and its object is to provide a representation procedure of celluloid animation different from the existing one by adding value thereto by utilizing digitized celluloid animation.

It is possible to store classical animation semipermanently by digitizing and to provide observers with very beautiful images having superior power of representation by value-adding, for example, converting a monochrome image to a colored one. Also, it is possible to provide new representation of celluloid animation, which has not been seen in the past, by composing into three-dimensional CG space and to provide delicate sense so as to excite transcendent sense thereby immersing into two-dimensional space by using a new stereoscopic technique. Further, by using specific projecting model in composition into the three-dimensional CG space, it is possible to provide an image of less deformation.

Thus, in the present invention, the film image (especially animation) is digitized, separated into “celluloid images”, applying restoration to the separated image and performing image processing such as recomposition. Incidentally, the celluloid image is a one constituting any frame in a film and includes an object such as person and background image. The celluloid image includes a celluloid used in formation of animation. The celluloid image may be layers.

### BRIEF DESCRIPTION OF THE DRAWINGS

FIG. 1 shows a system arrangement of an apparatus for producing a stereoscopic image according to a first embodiment of the present invention.

FIG. 2 shows an interior construction of the apparatus for producing a stereoscopic image according to the first embodiment of the present invention.

FIG. 3 shows an example of a camera panning image in celluloid animation.

FIG. 4 shows an example of a camera panning image of a celluloid image in plane projection.

FIG. 5 shows an example of a camera panning image of a celluloid image in cylindrical mapping.

FIG. 6 shows a system arrangement of an apparatus for producing a stereoscopic image according to a second embodiment of the present invention.

FIG. 7 shows an interior construction of the apparatus for producing a stereoscopic image according to the second embodiment of the present invention.

FIG. 8 is a flow-chart showing the contents of processing in the first embodiment of the present invention.

FIG. 9 shows a hardware arrangement of a computer to which the present invention is applied.

### DESCRIPTION OF THE EMBODIMENTS

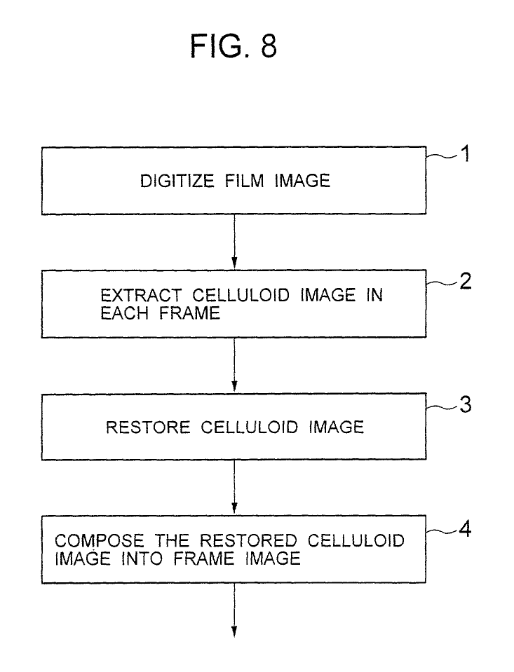

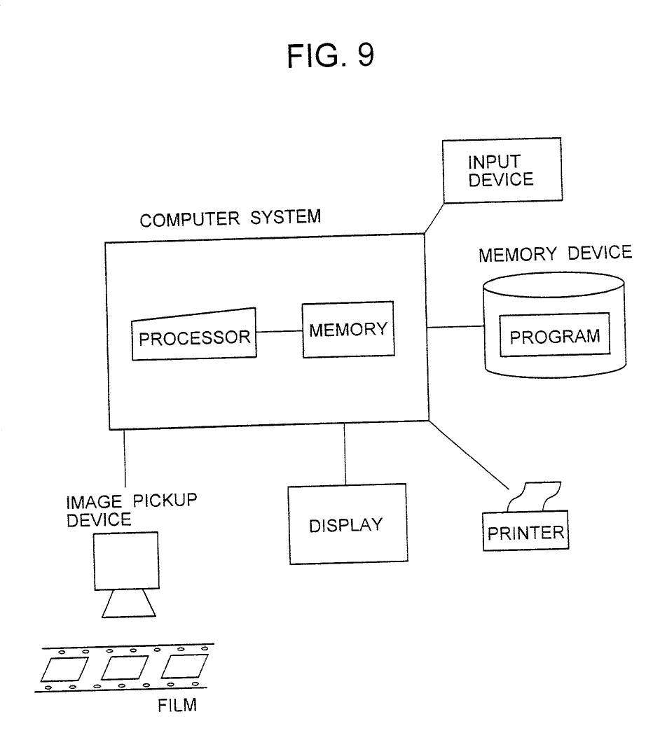

First, the outline of an embodiment will be described with reference to FIG. 8. First, an image recorded on a film is digitized by a film scanner (step 1). The image pickup device shown in FIG. 9 includes a film scanner additionally performing digitization and a camera. When the camera is used, the film image is picked up and inputted from each of the frames constituting the film and the inputted film image is digitized. Next, the celluloid image constituting the film image is extracted from the digitized film image (step 2). The extraction of the celluloid image includes extraction of an object included in the image by using characteristics such as outline of an object included in the image. Next, restoration is applied to the extracted celluloid image (step 3). The restoration includes at least one of supplement of the blank part produced by the extraction of the celluloid image, removal of noise on the film image, coloring process and discoloring process. Here, the coloring process and discoloring process may be selected by a user's indication. Further, the supplement may be conducted by using a second celluloid image corresponding to the first-mentioned celluloid image and constituting a frame having a predetermined relationship with the frame including the celluloid image to be supplemented. The predetermined relationship includes one of the relatinships such that the celluloid are adjacent to each other, or the frames exist in a range of a predetermined number of frames, or the frames are designated by a user. Next, a plurality of restored celluloid images constituting predetermined frames are composed together (step 4). Further, at least one of coloring process, discoloring process, deforming process and scale reduction changing process may be applied to the plural composed celluloid images.

Incidentally, the above processing is capable of being practiced by a computer system as shown in FIG. 9.

Next, an embodiment of the present invention will be described in detail. Although an animation is used as a film image in this embodiment, the present invention is applicable to other than the animation.

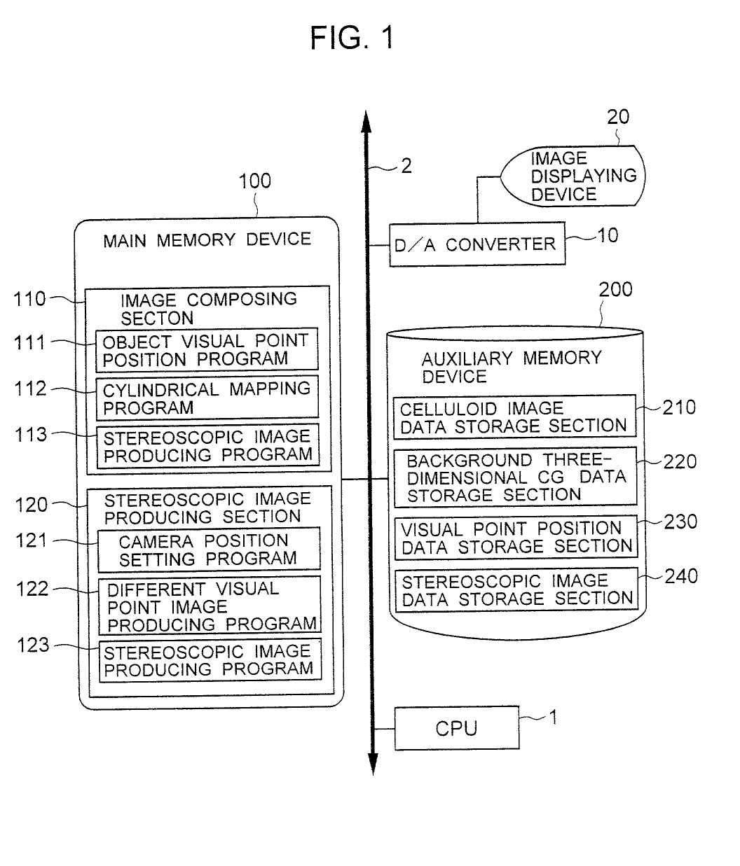

FIG. 1 shows an arrangement of the whole system in the embodiment of the present invention. This system includes a CPU 1 for conducting calculation and control based on a program, a main memory device 100 including a memory for storing data and programs or the like, and an auxiliary memory device 200 such as hard disk.

Also, the system includes a D/A converter 10 for converting digital image data into analog data, an image displaying device 20 for displaying images, and a bus 2 for connecting the above components to each other.

The auxiliary memory device 200 includes a celluloid image data storage section 210 for storing celluloid image data obtained by separating a digitized animation into layers, a three-dimensional CG data storage section 220 for storing background three-dimensional CG data with which celluloid image data 210 is composed, a visual point position data storage section 230 for storing false camera position in three-dimensional space for two-dimensional celluloid image data 210, and a stereoscopic image data storage section 270 for storing stereoscopic image obtained from two different visual point images obtained by shifting a camera position in a horizontal direction.

The main memory device 100 includes an image composing section 110 and a stereoscopic image producing section 120.

The image composing section 110 includes an object visual point determining program 111 for determining a visual point position of an object in the celluloid image 210 based on visual point position data 230 of two-dimensional celluloid image 210 for composing celluloid image data 210 in the celluloid animation at a proper position in three-dimensional CG data 220 providing background image, cylindrical mapping program 121 for mapping a celluloid image 210 in cylindrical model so that no distortion is produced in two-dimensional celluloid image when a camera is panned in a three-dimensional space, stereoscopic image composing program 113 for composing a celluloid image 210 in a three-dimensional space by adjusting a size of the cylindrical model based on visual point data 230 depending on the distance from a camera to an object in the celluloid image. Incidentally, the cylindrical model is used as an object for mapping because the distortion by rotation is less in panning of a camera.

The stereoscopic image producing section 120 includes a camera position setting program 121 for producing images corresponding to the positions of right and left eyes as viewed from a camera position or a view point. In this case, the camera position is horizontally moved in equal distances in the right- and left-hand while maintaining the view point constant and setting two kinds of camera parameters. Further, the stereoscopic image producing section 120 includes different visual point image producing program 122 for producing images at respective camera positions set by the camera position setting program 121, stereoscopic image producing program 123 for producing a stereoscopic image by composing two different view point images. There are various kinds of stereoscopic images. When two types of images, such as polarized light type or liquid crystal shutter type, are required, images for right- and left-hand eyes are produced respectively and composed together. In the anaglyph type in which the right- and left-hand images are distinguished by red and blue colors, the right- and left-hand images are produced with respective corresponding colors and composed together.

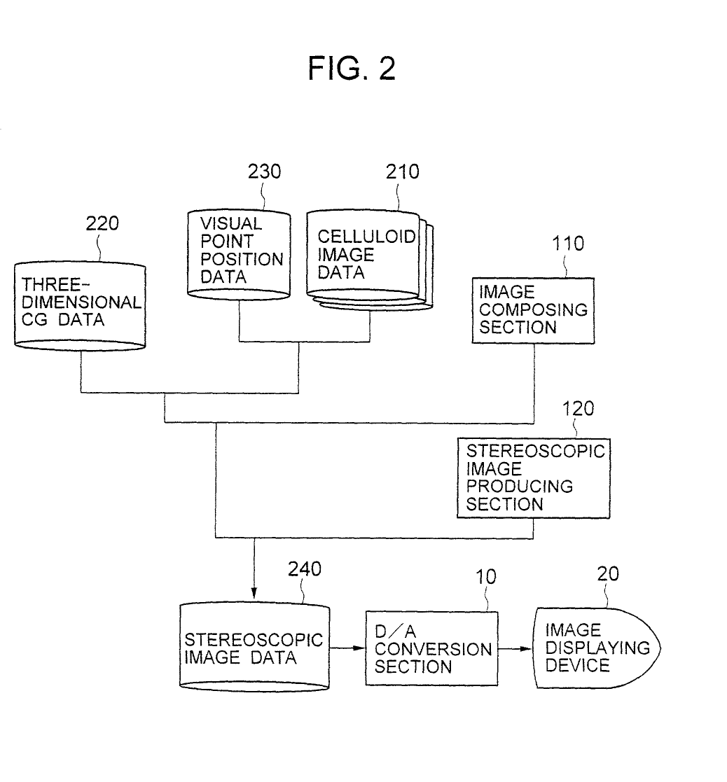

FIG. 2 shows an interior construction in this embodiment.

First, celluloid image data 210 to be composed in a three-dimensional space, visual point position data 230 indicating a position of a visual point to an object such as character included in the celluloid image data 210, and three-dimensional CG data 220 are used such that a smooth composite image is produced in an image composing section 110 by setting the celluloid image data 210 in a three-dimensional space so that the visual points of the celluloid image data and three-dimensional CG data coincide with each other. When setting the celluloid image data in the three-dimensional space, the distortion of image in the camera pan is reduced by mapping the celluloid image data 210 on a cylinder with the aspect ratio being fixed. Based on an image composing method like this, a stereoscopic image data 240 is produced by composing images produced by setting a camera at different view points in the stereoscopic image producing section 120. The produced stereoscopic image data 240 are converted to analog data in D/A conversion section 10 and outputted to image displaying device 20. In this case, the display of the stereoscopic image data may be on other than the image displaying device such as a projector but a paper sheet to be printed out. Further, the data may be stored in a memory device or outputted to VTR without display.

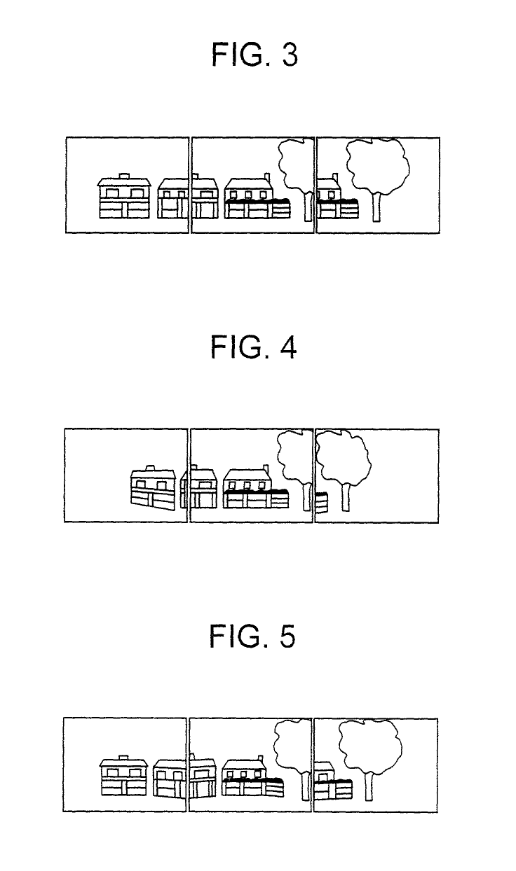

FIG. 3 shows an example of an image produced in camera panning scene in the conventional celluloid animation. In order to represent a camera panning scene in formation of a celluloid animation, it is general to draw a laterally long image and take a picture of the image while laterally scrolling the image with the camera fixed. Therefore, it is possible to reduce the distortion of the image as produced.

FIG. 4 shows an example of images produced in camera panning scene when two-dimensional celluloid image data 210 are set in a three-dimensional space in one plate. In this example, the distortion of the image is remarkable as the rotating angle of the camera is increased.

FIG. 5 shows an example of images produced in camera panning scene when two-dimensional celluloid image data 210 are set in a three-dimensional space by cylindrical mapping.

As compared with a case as set in one plate, the distortion of the image hardly occurs as the rotation angle of the camera is increased and it is possible to obtain the same result as that in the camera panning scene in the conventional celluloid animation.

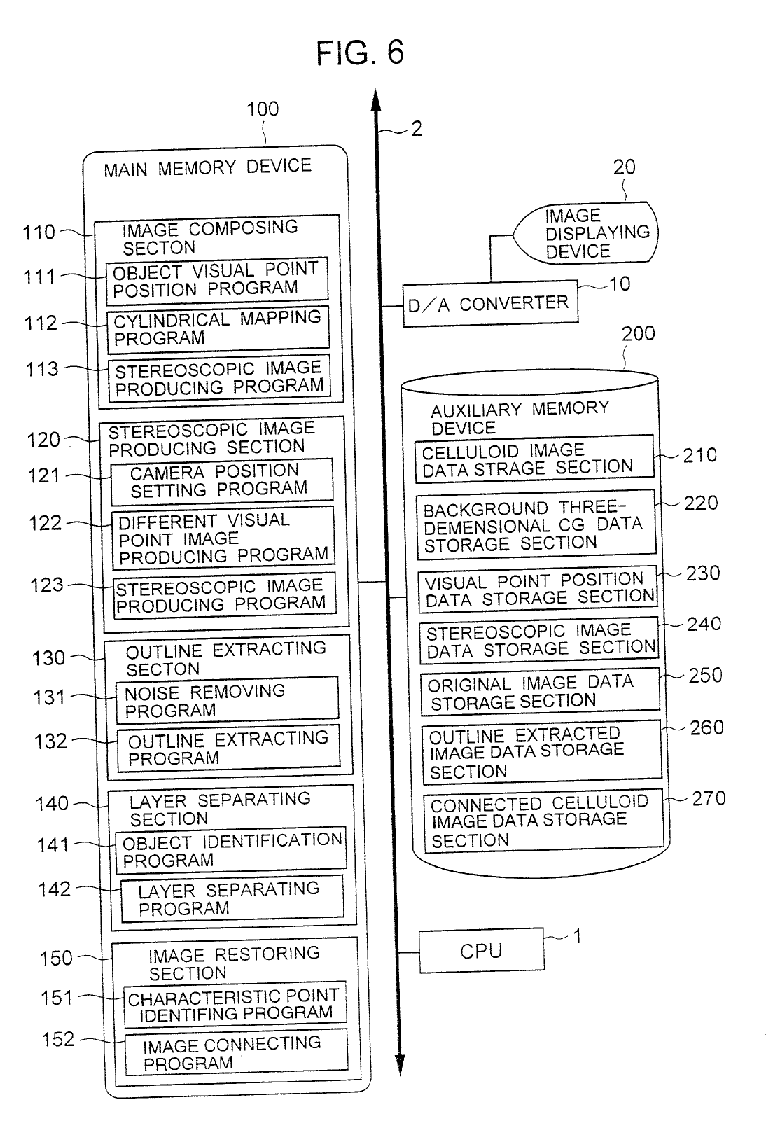

FIG. 6 is a diagram showing an arrangement of the whole system in a second embodiment.

In addition to the arrangement in the first embodiment, the process for obtaining a celluloid image data from an existing animation is included. In addition to FIG. 1, it includes an original image data storage section 250 for storing celluloid animation image data produced by digitizing animation data stored as analog data in a film by scanning with a film scanner or produced by drawing preliminarily in digital form, and outline extracted image data storage section 260 for storing outline data which is obtained from the original image data 250 by making distinct an outline of an object included in the image. The data in which the background part and the object part are separated into different layers by recognizing the background and the object based on the outline extracted image data are stored in the celluloid image storage section. Further, it includes connected celluloid image data storage section 270 for storing an image produced by restoring a series of consecutive celluloid images 210 obtained by cutting at desired positions to an original laterally long celluloid image based on characteristic information.

The main memory device 100 includes, in addition to FIG. 1, outline extracting section 130, layer separating section 140 and image restoring section 150.

The outline extracting section 130 includes noise removing program 131 for removing noise added to the film. When the film data are scanned, the film data are sometimes treated for removing scratches and dust by cleaning by water rinsing and/or chemical process from the film data before scanning the same and thereafter, subjected to reprinting. However, only the above process is sometimes insufficient to completely repair the scratches and remove the dust so that the dust and/or scratches remained in the celluloid are taken into the digitized image. Further, in the case of celluloid animation, it is required to remove the celluloid shadow when a picture of a plurality of celluloid as laminated is taken. By “celluloid shadow”, it is indicated that when a picture of celluloid animation is taken by laminating a plurality of celluloid, the shadow of the celluloid of the upper layer is remained so that the outline is doubled and/or becomes obscure due to lamination of plural celluloid, the thickness of the celluloid (about 0.6 mm/sheet), the light being projected from obliquely upper side, and/or the unequality in the celluloid quality. By removing those noises, it is possible to obtain an image beautiful and easy for image processing. By the outline extracting program 132, the image from which the noise is removed is processed to make distinct the outline of an object. The thin parts or break points of the outline are repaired thereby reconstructing the image. By extracting a line with no break, the identification of an area is made easy thereby making easy the separation of layers and coloring process.

The layer separating section 140 includes object identification program 141 for identifying an object included in the animation based on the outline extracted image data 260. With reference to the images in the before and behind frames, moving characters such as persons, animals or vehicles, less movable objects and background-like object are determined. Then, the images of the characters, other objects, background image, special effects or the like are separated by layer separating program 142 and stored as respective different images. In this case, if desired, the part covered by an object drawn on an upper layer is repaired. This may be done by extracting the corresponding part from another layer and adding it to the part or by newly painting.

Further, in the conventional animation photographed in a film, it hardly occurs that the images of all the frames are different from each other and it is usual that two or three consecutive films commonly use the same image. Further, the manner in the common use of a frame image is not the same in all the layers and sometimes the timing of change may be different. Also, the images of a plurality of frames are sometimes repeatedly used in a celluloid. For this reason, it is unnecessary to apply the repairing and the coloring process to all the frames, but it is sufficient to apply the process only once to the overlapped frames. By preparing data base for the degree of overlapping, the amount of the processing work can be reduced.

In the image restoring section 150, the celluloid image data 210 for the part including the camera panning scene in the celluloid animation is first read out. It includes characteristic point identifying program 151 by which the characteristic point of an object such as building, character and animal included in the consecutive layers is tracked thereby determining the correspondency between the layers, and image connecting program 152 by which laterally long connected celluloid image data 270 is produced from a plurality of celluloid image data 210 based on the characteristic point data.

In the image composing section 100 and the stereoscopic image producing section 120, the connected celluloid image data 270 is used as the two-dimensional celluloid image data to be composed.

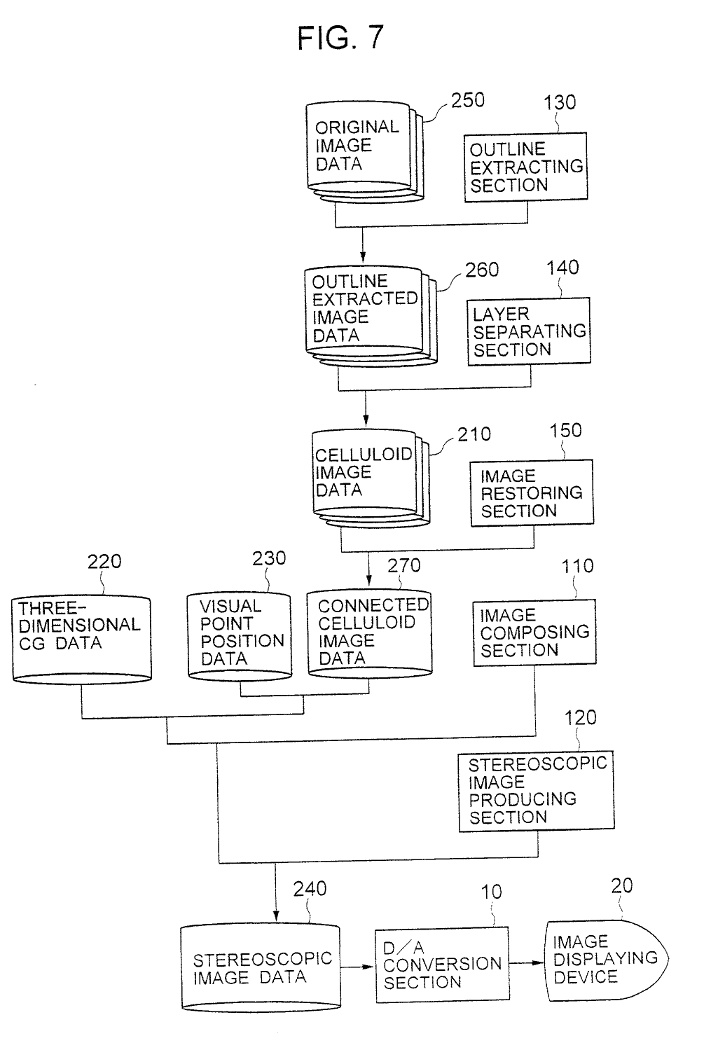

FIG. 7 is a diagram showing an arrangement of the whole system in the second embodiment.

In addition to the components of the first embodiment, it includes a process for obtaining celluloid image data from the existing animation data. A process for producing the celluloid image data and the connected celluloid image data 270 to be composed with the three-dimensional CG data 220 is added to FIG. 2. First, based on the image obtained by scanning a film or the original image data 250 of the celluloid animation preliminarily produced in digital fashion, noise is removed in the outline extracting section 130 and a process for making distinctive the outline by filtering is carried out thereby producing the outline extracted image data 260. The outline extracted image data 260 thus produced is processed in the layer separating section 140 to identify the objects such as background and characters based on the image information in the consecutive before and behind frames and separate the layers depending on the objects thereby producing celluloid image data 210. The plural consecutive celluloid image data 210 in the scene including the camera panning are processed in the image restoring section 150 to produce a laterally long connected celluloid image data 270. The remaining portion is the same as FIG. 2.

What is claimed is:

1. A method of secondary use of a film image in which a predetermined image process is applied to an image recorded on a film, said method comprising the steps of:
inputting a film image from each of frames constituting said film,
digitizing said inputted film image,
extracting a celluloid image constituting said film image from said digitized film image,
applying restoration to said extracted celluloid image, and
composing a plurality of such restored celluloid images constituting a predetermined frame.

2. A method of claim 1, further comprising the step of composing said composed plural celluloid images with computer graphic data.

3. A method of claim 2, wherein said step of composing computer graphic data comprises the steps of,
calculating a distance from an object included in said extracted celluloid image to a visual point,
determining a projecting model to be applied according to the calculated distance to said visual point,
mapping celluloid image data in said projecting model to be applied, and
producing stereoscopic image data by composing said celluloid image data mapped to said projecting model with a preliminarily prepared three-dimensional CG data.

4. A method of claim 1, further comprising the step of applying to said composed plural restored celluloid images at least one of coloring process, discoloring process, deforming process and scale reduction changing process.

5. A method of claim 1, said step of applying restoration comprises at least one of supplement of a partial area which becomes blank as a result of extracting the celluloid image, removal of noise on the film image, coloring process and discoloring process.

6. A method of claim 5, wherein the supplement of the partial area is carried out by using a second celluloid image constituting a second frame having a predetermined relationship with said first-mentioned predetermined frame and corresponding to said first-mentioned celluloid image.

7. A method of claim 6, wherein said second frame having a predetermined relationship is a frame adjacent to said predetermined frame.

8. A computer apparatus for conducting a secondary use of a film image in which a predetermined imaging process is applied to an image recorded on a film, said apparatus comprising:
a memory device for storing a program by which said computer apparatus conducts a predetermined process,
an image inputting section to which a film image is inputted from each of frames constituting said film,
a processing section connected to said inputting section and arranged for digitizing said inputted film image according to said program, extracting celluloid image constituting said film image from said digitized film image, applying restoration to said extracted celluloid image and composing a plurality of such restored celluloid images which constitute a predetermined frame, and
an outputting section connected to said processing section and outputting a plurality of said celluloid images as composed.

9. A computer apparatus according to claim 8, wherein said memory device stores computer graphic data, and said processing section composes said plural celluloid images as composed with said computer graphic data according to said program.

10. A computer apparatus according to claim 9, wherein said processing section operates according to said program to produce stereoscopic image data by calculating a visual point distance between an object included in said extracted celluloid image and a visual point, determining a projecting model to be applied, mapping celluloid image data to said projecting model and composing said celluloid image data as mapped to said projecting model with a preliminarily prepared three-dimensional CG data.

11. A computer apparatus according to claim 9, wherein said processing section operates according to said program to apply at least one of coloring process, discoloring process, deforming process and scale reduction changing process to said plurality of composed celluloid images.

12. A computer apparatus according to claim 11, wherein said restoration in said processing section includes at least one of supplement of a partial area which becomes blank as a result of extracting the celluloid image, removal of noise on the film image, coloring process and discoloring process.

13. A computer apparatus according to claim 12, wherein said processing section operates the supplement of the partial area by using a second celluloid image constituting a frame having a predetermined relationship with said first-mentioned predetermined frame and corresponding to said first-mentioned celluloid image.

14. A computer apparatus according to claim 13, wherein said frame having a predetermined relationship is a frame adjacent to said first-mentioned predetermined frame.

15. A computer apparatus according to claim 8, wherein said outputting section includes at least one of a display for displaying a plurality of said composed celluloid images and a printer for printing said composed celluloid image.

16. A program product capable of being stored in a memory medium readable by a computer and adapted to operate said computer to conduct the steps of;
inputting a film image from each of frames constituting a film,
digitizing said inputted film image,
extracting a celluloid image constituting said film image from said digitized film image,
applying restoration to said extracted celluloid image, and
composing a plurality of such restored celluloid images constituting a predetermined frame.

17. A program product according to claim 16, capable of operating said computer to further conduct the step of composing said plural composed celluloid images with computer graphic data.

18. A program product according to claim 17, wherein said step of composing said computer graphic data includes the steps of;
calculating a distance from an object included in said extracted celluloid image to a visual point,
determining a projecting model to be applied according to the calculated distance to said visual point,
mapping celluloid image data in said projecting model to be applied, and
producing stereoscopic image data by composing said celluloid image data mapped to said projecting model with a preliminarily prepared three-dimensional CG data.

19. A program product according to claim 16, capable of operating said computer to further conduct the step of applying to said composed plural restored celluloid images at least one of coloring process, discoloring process, deforming process and scale reduction changing process.

20. A program product according to claim 18, wherein said step of applying restoration comprises at least one of supplement of the blank part produced by the extraction of the celluloid image, removal of noise on the film image, coloring process and discoloring process.

21. A program product according to claim 20, wherein the supplement of the partial area is carried out by using a second celluloid image constituting a second frame having a predetermined relationship with said first-mentioned predetermined frame and corresponding to said first-mentioned celluloid image.

22. A program product according to claim 21, wherein said frame having a predetermined relationship is a frame adjacent to said first-mentioned predetermined frame.
